(19) United States
(12) Patent Application Publication
(10) Pub. No.: US 2016/0048935 A1
(43) Pub. Date: Feb. 18, 2016

(54) COMPREHENSIVE QUANTITATIVE AND QUALITATIVE MODEL FOR A REAL ESTATE DEVELOPMENT PROJECT

(71) Applicant: Create Inc., Washington, DC (US)

(72) Inventors: Stefan Martinovic, Washington, DC (US); Edward R. Switzer, Washington, DC (US)

(21) Appl. No.: 14/925,650

(22) Filed: Oct. 28, 2015

Related U.S. Application Data
(63) Continuation of application No. 13/792,464, filed on Mar. 11, 2013.
(60) Provisional application No. 61/725,691, filed on Nov. 13, 2012.

(51) Int. Cl. G06Q 50/16; G06Q 40/02

(52) U.S. Cl. CPC G06Q 50/165; G06Q 40/025

(57) ABSTRACT

Methods, systems, and apparatus, including computer programs encoded on a computer storage medium, for providing a user interface for specifying details of a development project, receiving, through the user interface, user-input specifying a type for the development project, a location for development project, and a financing structure for the development project, determining one or more projected outcomes for the development project based on data for the specified type, location, and financing structure of the development project, and, providing, through the user interface, an analysis of each of the one or more projected outcomes.

### CROSS-REFERENCE TO RELATED APPLICATIONS

This application is a continuation of U.S. patent application Ser. No. 13/792,464, filed on Mar. 11, 2013, which claims the benefit of U.S. Pat. App. No. 61/725,691, filed on Nov. 13, 2012, which are incorporated herein by reference.

### BACKGROUND

This specification describes systems and processes for an analysis tool for use in the real estate industry that provides consistent, transparent, and efficient analysis of a real estate development project.

The real estate industry can include real estate developers construction companies (e.g., commercial and heavy construction contractors), contractors, hospitality companies (e.g., hotels, motels, and resorts), Real Estate Investment Trusts ((REITs) whose industry size is measured by market capitalization and can vary significantly from year to year), investors, construction lenders, brokers, agents, property managers, database providers, insurance companies, and financial and other consultants. Many of these industries can be highly fragmented where a large number of companies generate the majority of the industry revenue.

Companies included in residential real estate development industry can subdivide land into lots for subsequent sale to builders. In addition, companies that subdivide land into commercial tracts and industrial parks may also be included in the residential real estate development industry.

Companies included in the residential property investment industry, in general, buy single-family and multifamily residential properties and generate profits by renting or reselling these properties. Residential properties can include single-family dwellings such as houses, condominiums, townhouses, and multi-family dwellings such as apartment buildings. Companies in this industry may manage the property themselves or may hire a property management company.

Companies included in the commercial real estate & construction lending industry can provide loans and other financing products for commercial real estate and commercial or residential real estate construction. Examples of products and services provided include residential and commercial real estate construction loans, land development loans, and unsecured front-money loans. Companies that primarily provide residential mortgage loans are covered separately.

Companies included in the architectural & engineering services industry can engage in planning and designing residential, institutional, commercial, leisure, and industrial buildings and structures, as well as land areas for these and other types of projects. Engineering services may also be provided as part of the design and development of buildings, structures, and land areas. Additionally, these companies may provide advice, feasibility studies, preliminary and final plans, as well as offer technical services during the stages of the design up to completion of the project.

Companies included in the specialty contractors industry can provide specialty trade services related to construction. Examples of services provided by these companies can include building demolition, carpentry, concrete work, drywall and plaster work, finishing work, floor laying, foundation and framing, heating, air conditioning, and ventilation (HVAC) installation, masonry, painting and wall covering, plumbing, and roofing and siding installation.

### SUMMARY

Success in the real estate development industry can be based on two interdependent skill sets: first, the ability to accurately understand and underwrite a potential project as an investment; and second, the ability to assemble and manage working relationships with teams of consultants and project stakeholders. Currently, real estate developers can employ teams of analysts and subject matter experts in the areas of construction, entitlement, financing, and leasing in order to seek out and process data points pertinent to projects that they analyze. The rationale behind this is that since the naissance of the industry, real estate developers have viewed each real estate deal as a wholly unique transaction. This view of each real estate deal may be largely based on the myriad of moving parts and complexities inherent in managing the many components of the real estate development process. While a real estate transaction can be a complex and nuanced process, if the process is broken down to the utmost level of granularity, the process can effectively be commoditized. It is possible to accurately model the real estate transaction by understanding the drivers behind each of the granular data points and then combining the all of the data points in order to frame the analysis of the overall project. Initial modeling of a potential transaction can be critical in order to assess baseline project viability before further capital, time, and other resources are spent.

Unlike many other types of investments, the performance of real estate transactions and development may not be based on insider knowledge or trade secrets but rather on the ability to have awareness of and to deftly manipulate a finite set of inputs and data in the most advantageous way in order to optimize project returns. Governments and other stakeholders may actively seek to make data available on real estate development projects in order to encourage private parties to convert underutilized properties to their best and highest use. How developers go about obtaining data on ongoing, new, and potential real estate development projects can be dependent on their professional experience, analytic ability, and relationships with key stakeholders.

For example, software products can provide a user with real estate development project modeling tools that can perform a series of calculations based on a wide array of user inputs. While providing a stable and consistent platform with which to analyze deals, in most cases the users must be highly skilled in knowing the functionality of the software and ensure that all inputs are populated accurately and updated as needed. Users often undergo costly and extensive training and certification processes. Many of these software products are unable to link inputs that a user enters about a project to their real world drivers, requiring a user input their project assumptions in order to generate calculations. This can lead to inaccuracies based on user errors that can result in “garbage in, garbage out.” In addition, many of the software products, in order to achieve the desired result for a project model, require a very skilled, highly trained user with a mastery of spreadsheet logic and a firm grasp on the relationships between all of the data points in order for the project model to provide accurate and useful results.

An automated analytic framework can allow users (e.g., developers, consultants) to tap their experience and apply analytics in an efficient way. The framework can provide a user with the tools needed to take their work product and share it in a streamlined and transparent manner with stakeholders that can participate or otherwise have an impact on the overall real estate development project. The relationships that can be formed in order to bring a real estate development project on line can be critical to the project's success and can be largely dependent on the transfer of knowledge of the project's specifics. These transfers of knowledge can be highly repetitive and may not provide the most current, sound base of knowledge with which to assess a real estate development project.

In general, one innovative aspect of the subject matter described in this specification may be embodied in systems and processes used for an automated analytic framework that can synthesize relevant real-time property, financial, market, and demographic data with industry best practices and logic to provide investment insight on a development opportunity. A Comprehensive Real Estate Analysis Toolkit (CREĀT) can utilize a minimum number of inputs and can use the inputs to source data needed to populate a myriad of real estate development project assumptions. For example, the CREĀT can provide three questions that can form the crux of a development deal: (1) what do you want to build, (2) where do you want to build it, and (3) how do you want to finance it. The answers to these three questions can provide the inputs necessary in order to source the data needed to populate the real estate development project assumptions.

In addition, the CREĀT can allow users to manually input assumptions as real-world data becomes available, replacing calculated assumptions and reflecting the iterative process of real estate development. The changes to project assumptions can be logged and can allow the user to monitor any fluctuation in the value of the real estate development project over time, as the information transitions from assumption to hard data and as real-time data is updated. A range of anticipated project outcomes can be executed through a Monte Carlo simulation that takes into account a random sampling of variable parameters to yield a distribution of projected returns. The integration of real-time data with a statistically significant financial model with change tracking can provide a transparent, consistent, and accurate baseline from which to analyze a project. The CREĀT can integrate project management and scheduling functionality in order to track a real estate development project's progress throughout the development process and to benchmark the real estate development's progress against an initially conceived schedule, guiding a user through the real estate development process.

In general, another innovative aspect of the subject matter described in this specification may be embodied in methods that include the actions of providing a user interface for specifying details of a development project, receiving, through the user interface, user-input specifying: a type for the development project, a location for development project, and a financing structure for the development project, determining one or more projected outcomes for the development project based on data for the specified type, location, and financing structure of the development project, and providing, through the user interface, an analysis of each of the one or more projected outcomes.

Other embodiments of these aspects include corresponding systems, apparatus, and computer programs, configured to perform the actions of the methods, encoded on computer storage devices.

These and other embodiments may each optionally include one or more of the following features. For instance, the data comprises one or more of property data, development data, market data, financial data, and demographic data. The actions include receiving, through the user interface, user-input for the data. Determining one or more projected outcomes for the development project includes executing a Monte Carlo simulation. The actions include receiving, through the user interface, a user selection of component assumptions influencing the one or more projected outcomes as an implementation of the development project, and tracking progress of the implementation of the development project. The actions include receiving, through the user interface, a user selection of component assumptions influencing the one or more projected outcomes as an implementation of the development project to submit to a portal, and providing the implementation of the development project to the portal. The actions include receiving, from the portal, feedback regarding the implementation of the development project, refining the analysis of the projected outcome of the implementation of the development project based on the received feedback, and providing, through the user interface, the refined analysis of the projected outcome of the implementation of the development project. Providing a user interface for specifying details of a development project includes providing a user interface to a mobile computing device, and receiving, through the user interface, user-input specifying a type for the development project, a location for development project, and a financing structure for the development project includes receiving user-input based on a geographic location of the mobile computing device.

The details of one or more embodiments of the subject matter described in this specification are set forth in the accompanying drawings, and the description, below. Other features, aspects and advantages of the subject matter will be apparent from the description and drawings, and from the claims.

### BRIEF DESCRIPTION OF DRAWINGS

Referring now to the drawings, in which like reference numbers represent corresponding parts throughout:

FIG. 1 is a diagram illustrating the inputs to and relationship between a CREĀT analytic platform and a CREĀT market portal.

FIG. 2 is a screen shot of an example user interface for the CREĀT.

FIG. 3 is a block diagram illustrating a project analytics platform showing the interoperability of analytic components of the CREĀT.

FIG. 4 is a screen shot of an example user interface that shows a location of a parcel of land for development.

FIG. 5 is an example chart that shows data sets, sources, and alternate sources for data points that are pertinent to the property and local market for a real estate development project.

FIG. 6 is a screen shot of an example user interface that shows return distribution for financial returns for a real estate development project.

FIG. 7 is a screen shot of an example user interface that shows floor area ratios (FAR) for various development scenarios.

FIG. 8 is a screen shot of an example user interface that shows building design and construction parameters for a real estate development project.

FIG. 9 is a screen shot of an example user interface that shows a program summary of tenant matching for a real estate development project.

FIG. 10 is a screen shot of an example user interface that shows a development budget for a real estate development project.

FIG. 11 is a screen shot of an example user interface that shows a capital stack of financing terms for a real estate development project.

FIG. 12 is a screen shot of an example user interface that shows revenue and expense projections in the form of an operating pro forma for a real estate development project.

FIG. 13 is a screen shot of an example user interface that shows a development schedule for a real estate development project.

FIG. 14 is a screen shot of an example user interface that shows a conceptual project rendering and massing study for a real estate development project.

FIG. 15 is a screen shot of an example user interface that shows construction contractors filtered by areas of expertise pertinent to the real estate development project being analyzed.

FIG. 16 is a screen shot of an example user interface that shows a response to a request for proposal (RFP).

### DETAILED DESCRIPTION

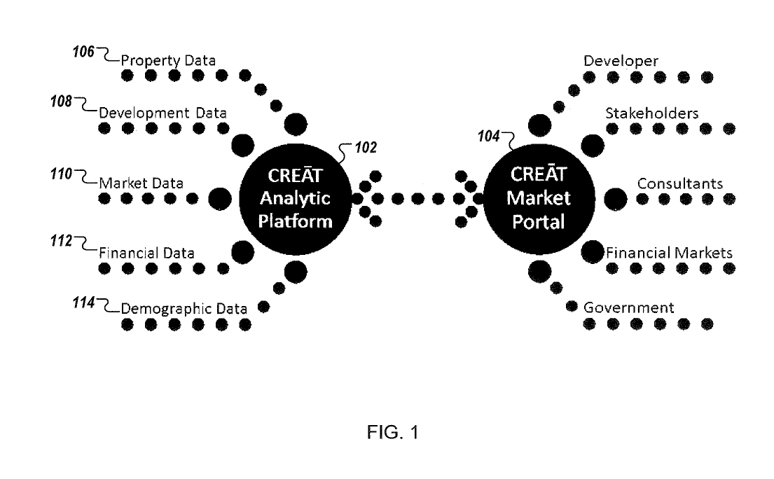

FIG. 1 is a diagram illustrating the inputs to and relationship between a CREĀT analytic platform 102 and a CREĀT market portal 104.

The physical and design components of the real estate development project can be captured through an assemblage of building design and construction parameters using the CREĀT analytic platform 102. For example, the parameters can provide data for input to the CREĀT analytic platform 102 that can include, but are not limited to, property data 106, development data 108, market data 110, financial data 112, and demographic data 114.

For example, shape, materials, and design attributes can be iteratively changed throughout the underwriting life cycle of the real estate development project. In some cases, the iterations can be supplemented using computer aided design compatibility (CAD-compatibility), which captures design evolution data derived from architect and consultant input. The captured data can be used to create a three-dimensional (3D) rendering and massing study of the real estate development project, which can provide a framework for qualitative analysis of the project by analyzing the design characteristics of the project in the context of the real estate development site's location and surrounding properties. In addition to the physical massing, a variety of architectural styles can be applied to the exterior rendering and can be set by default to reflect the architectural vocabulary of the surrounding area through a survey of prominent architectural styles in proximity to the target project. Value can be added to a quantitative analysis of the real estate development project by adjusting a financial modeling component included in the CREĀT in order to reflect design, construction, and program changes that have substantive implications for the real estate development project's economics.

An analytic output of the CREĀT at this stage in the review and analysis of the real estate development project can be a dynamic underwriting analysis of the project based on industry standard assumptions and best practices. Once complete, the analytic output can form the crux of a deal origination and consultant interface platform (e.g., CREĀT market portal 104) where real estate industry service providers seeking clients can be connected with developers who are seeking services. Value can be created at this stage in the project's analysis by allowing a developer to quickly share project parameters and analytic output with other stakeholders and service providers.

The underwriting of a real estate development project along with a log of changes that were made to any initial assumptions for the project can be sent electronically in a standardized format to one or more consultants as a model for the project for their review. An interested consultant can then vet any individual assumption and begin a dialogue with the developer using messaging functionality provided by the CREĀT in order to come to a complete understanding of the project and its implications. The consultant can gauge their interest, scope of involvement, and pricing for the project and provide estimates to the developer that further refine the project's analytics and impact the project's underwriting. A consultant can provide estimates based on their anticipated scope of work and return the model for the project directly to the developer incorporating any changes they have made to the model which may impact the real estate development project's underwriting.

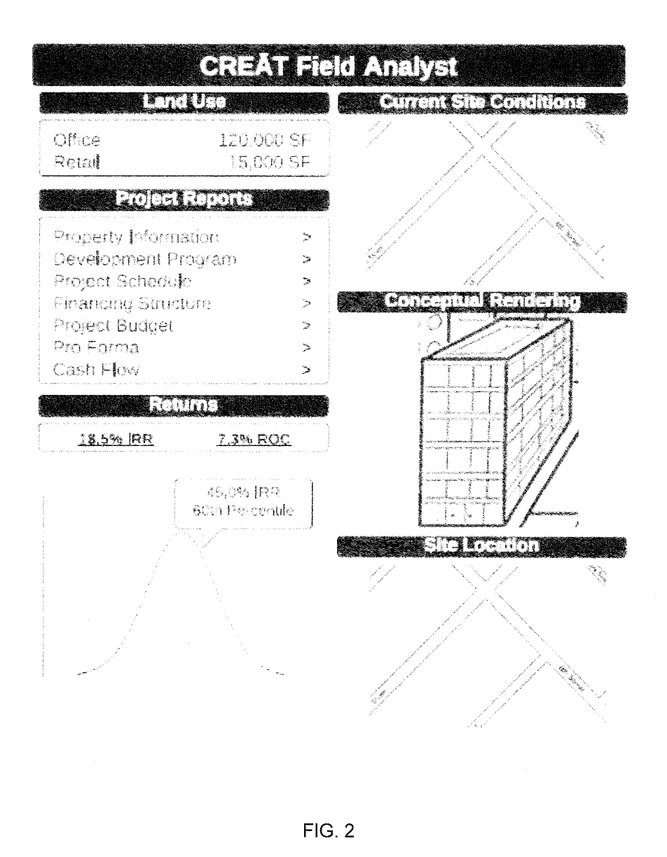

In some implementations, the CREĀT can include a user interface for a computing device. FIG. 2 is a screen shot of an example user interface for the CREĀT that can be implemented on a mobile computing device. The mobile computing device interface can allow the CREĀT to instantly and reliably analyze a real estate development project at a glance. For example, the mobile computing device interface can allow project team members (e.g., developers, consultants) to review and update project data and assumptions from anywhere and to inform project stakeholders and any additional members of the development team of any changes as they arise. Further, by combining the CREĀT analytic capabilities with a mobile computing device interface and geographic location functionality, real estate analysts can take the CREĀT into the field on their mobile computing devices and synthesize real world qualitative development knowledge that is gained from actually being on the ground analyzing a potential real estate development project with a suite of pertinent data and analytics to provide insight about properties in close proximity to the field user.

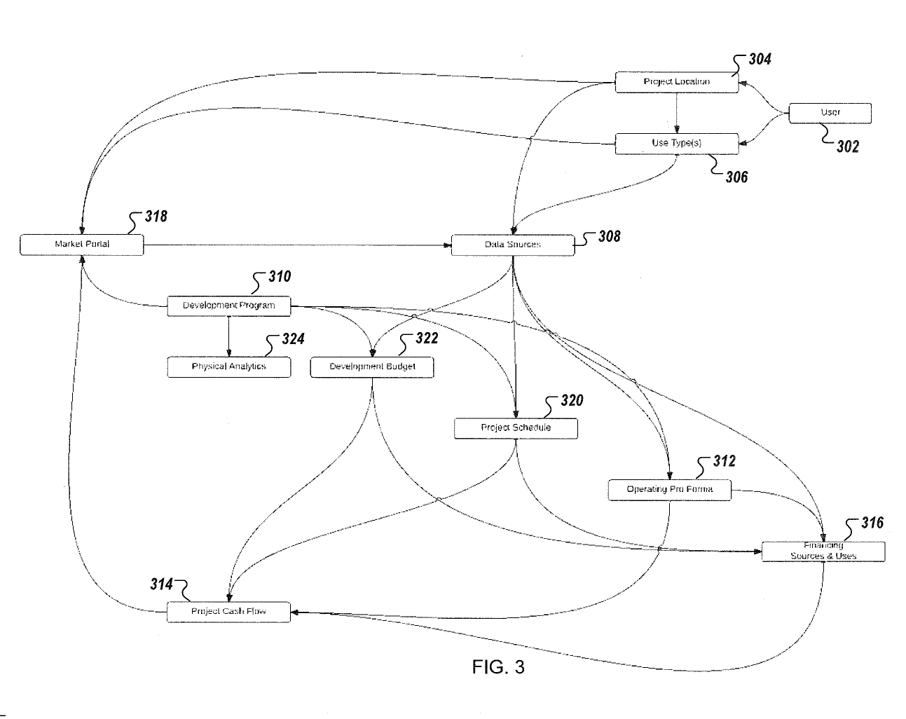

FIG. 3 is a block diagram illustrating a project analytics platform showing the interoperability of analytic components of the CREĀT.

Interface Overview

In some implementations, the CREĀT uses a “software as a service” (SaaS) model, which users can access using a web-based interface that can be hosted on the cloud. The CREĀT can assemble an analytics underwriting package that includes mission critical reports including a development and program summary, development budget, operating pro forma, development schedule, project cash flow, financing sources and uses, and a physical assessment of the development program including a preliminary design concept. The CREĀT is able to do this instantly with information derived from base assumptions.

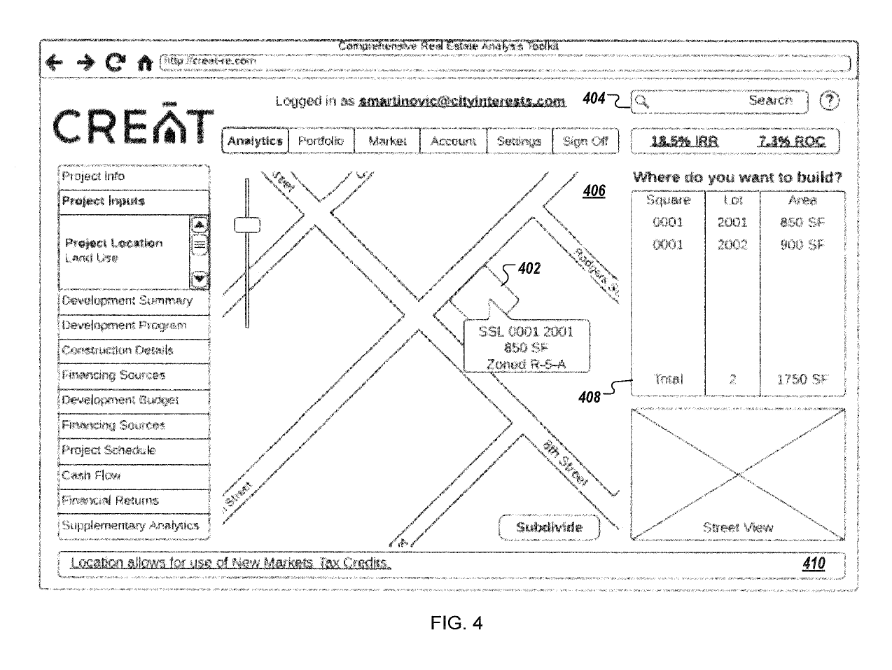

FIG. 4 is a screen shot of an example user interface that shows a location of a parcel of land 402 for development. Changes made to any assumption or input field included in the user interface are logged in real time and are associated with the time and date of change, user of record who edited the field, the ability to add a note explaining any changes made, and the ability to upload a document associated with the line item, which allows for the transparent record keeping and document management of critical items (e.g., architectural renderings, construction estimates). Powerful search functionality (e.g., using search box 404) can be integrated into the core of the user interface. The search functionality can allow a user to search for a particular report, data point, supporting document, or input without having to navigate a countless series of nested menus.

Referring to FIG. 3 and FIG. 4, upon initiating the analysis of a new real estate development project, a user (user 302) can input the location of the parcel in question (project location 304), which, for example, can be selected from a map interface (e.g., map interface 406) or by using one or more square and lot combinations (e.g., lot input 408). Lots can be combined or partially used in order to reflect subdivision of a site given particular dimensions. From this parcel selection, the CREĀT can aggregate many data points that are pertinent to the property and local market. When any changes to project assumptions that have an impact on other assumptions in the analytic platform occur, a notification bar 410 provides the user the ability to review the impact of changes to assumptions and/or inputs.

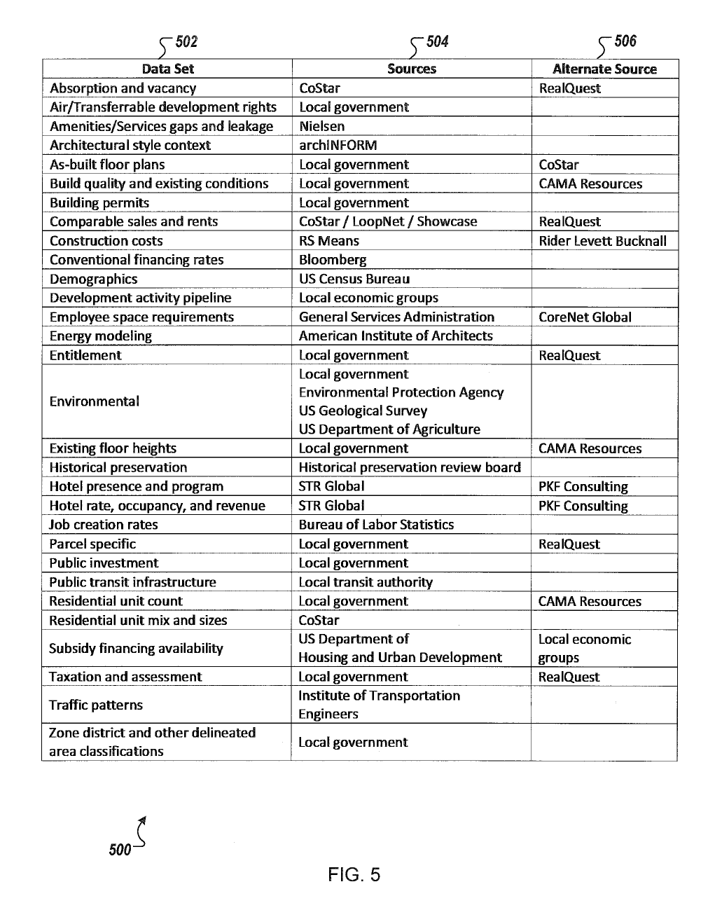

FIG. 5 is an example chart 500 that shows data sets 502, sources 504, and alternate sources 506 for data points that are pertinent to the property and local market for a real estate development project. If a structure exists on the development site that a project will be modeled on, the user can select the size and current net operating income (NOI) loss of the structure to be demolished, the in-place NOI of the existing structure, and the in-place vacancy which will be filled using CREĀT-populated assumptions. To promote the transition from the legacy NOI-modeling product standard, users can have the ability to upload a third party valuation file in order to extract pertinent data points for integration into the development analysis. When any changes to project assumptions that have an impact on other assumptions in the analytic platform occur, a notification bar 410 provides the user the ability to review the impact. The user can choose to review the notification to gain a better understanding of the implications, reject/undo the change and revert to the previous iteration of the analytic model, or to passively ignore the notification.

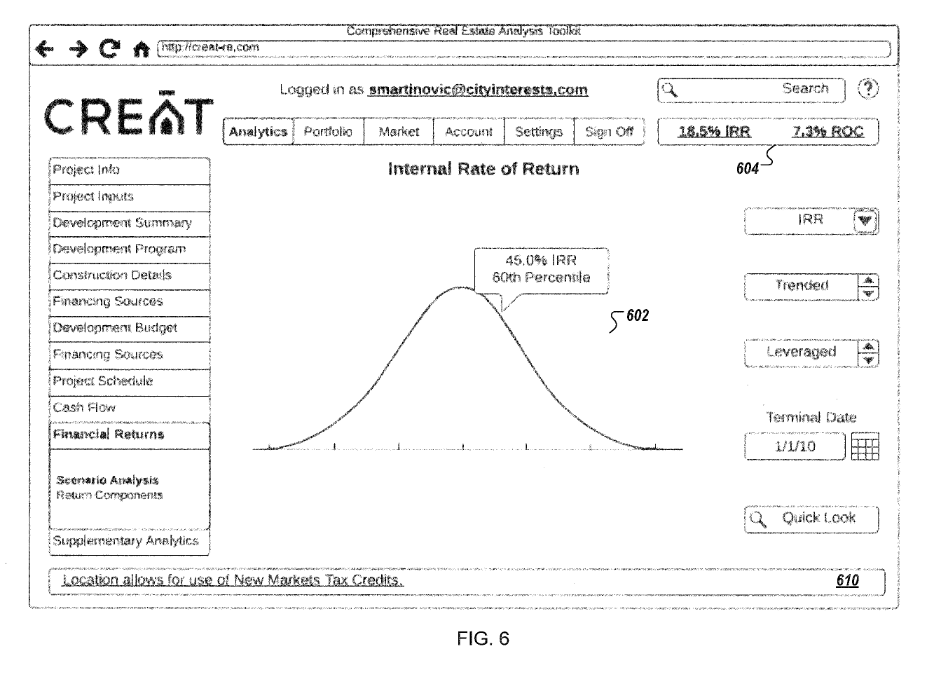

FIG. 6 is a screen shot of an example user interface that shows return distribution for financial returns for a real estate development project. Primary metrics which are of principal importance to users can include, but are not limited to: return on cost (net operating income/total development cost); cash on cash return (net operating income/total equity capital); equity multiple (total cash return/total equity capital); net present value (NPV) (discounted value of all project cash flows); internal rate of return (discount rate that sets NPV=0). Each of these return metrics can be made available to the user in both a trended/untrended and levered/unlevered format in order to represent the accounting for anticipated inflation/growth as well as the debt components of the project capital stack, respectively. When any changes to project assumptions that have an impact on other assumptions in the analytic platform occur, a notification bar 610 provides the user the ability to review the impact.

Development and Program Summary

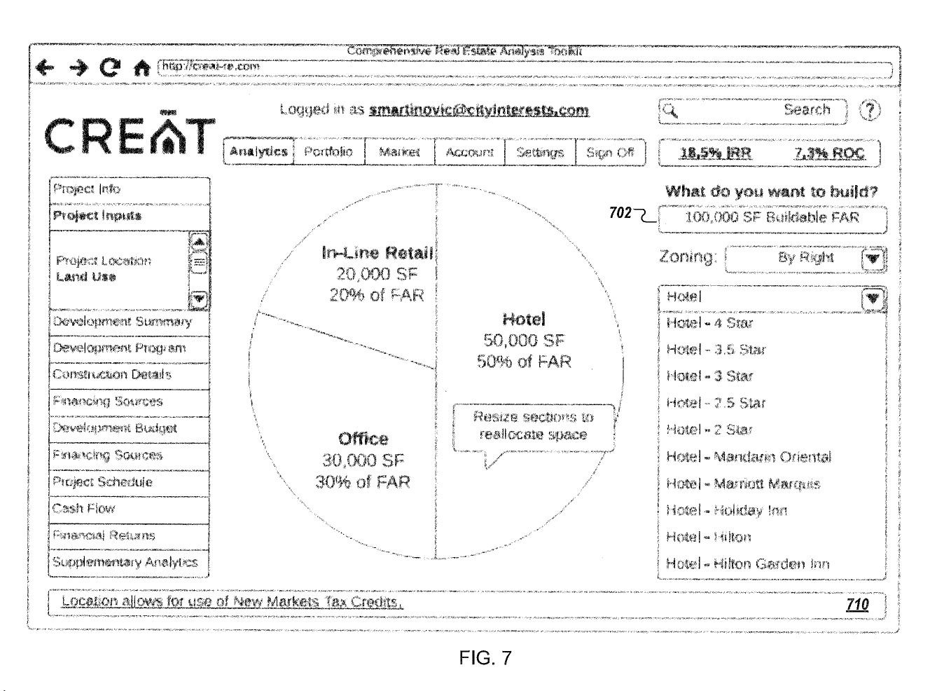

FIG. 7 is a screen shot of an example user interface that shows floor area ratios (FAR) for various development scenarios. Referring to FIG. 3 and to FIG. 6, the user can input project location use types (use type(s) 306). The user can input the desired land use (e.g., land use box 702) or allocation of mixed land uses, including type of parking (surface, below building/above grade, below building/below grade, structured parking garage, auto valet, none).

In addition to the user's ability to specify a desired use, an option for selection of a computer-optimized use is provided. The optimal use (also known as the best and highest use) can be the result of a comparison of returns of all product types that the target property may be used for. To supplement the ability to incorporate multiple land uses into a single project, the specification of ground floor retail is available to the user. Selection of the ground floor retail option can result in the interpretation of the zoning code to maximize the floor plate available to retail on the first level of the project and then to size the remaining space for other specified uses accordingly. Parking requirements can be allocated between construction of surface, below building/above grade, and below grade parking based on the amount of land area available for surface parking after determining the size of the ground floor relative to the site's land area. Spaces that are unable to be accommodated in surface lots can be by default programmed into the below grade parking share. The number of levels below grade can be determined by the number of below grade spaces needed relative to the site area and can also impact excavation costs and foundation type selection.

The data sourced from the location of the parcel (data sources 308) can be synthesized with the inputted land use data to determine that there is a maximum by-right development scenario. The maximum by-right development scenario outlines the maximum building size given the entitlement constraints of lot occupancy, FAR, building height, number of stories, and parking requirements. Zoning assumptions can default to a “by right” scenario which enables the devising of a building program that meets zoning regulations as a matter of right. Alterations to building program and physical attributes which conflict with “by right” zoning can prompt the user to integrate zoning adjustment (BZA) implications into the project's schedule and budget. In addition to maintaining the existing building size and core and shell development program (if applicable) and a “by right” scenario, the user can select a Planned Unit Development (PUD) zoning scenario which can default to up-zone the property in accordance with current regulatory trends. Alternatively, if the user chooses to change the zoning to a classification higher than the existing zoning, the entitlement process to a PUD is adjusted.

Any adjustments to the development program or any other aspect of the development that violates what is permitted by entitlement, market convention, or design constraints can prompt the user to confirm the override of the CREĀT-calculated recommendation(s) and will accordingly adjust the analytic outputs. The building attributes and land use allocation can be synthesized with the type and number of parking spaces as well as the construction and finish selections. The CREĀT can use these data points to create a development program summary, which provides the baseline information pertaining to the physical structure of the project. When any changes to project assumptions that have an impact on other assumptions in the analytic platform occur, a notification bar 710 provides the user the ability to review the impact with respect to the project location.

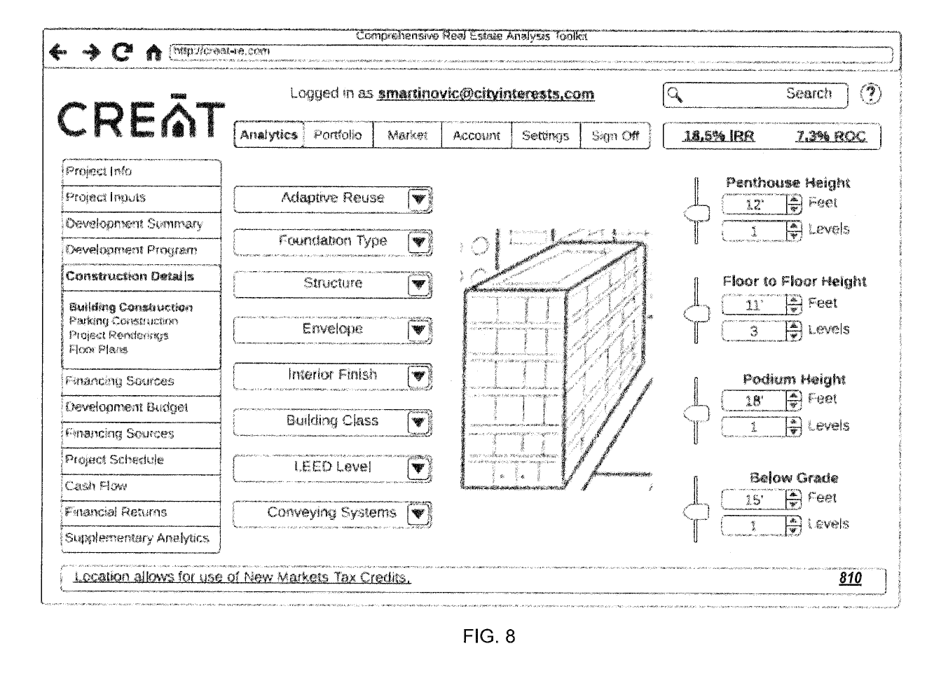

FIG. 8 is a screen shot of an example user interface that shows building design and construction parameters for a real estate development project. When any changes to project assumptions that have an impact on other assumptions in the analytic platform occur, a notification bar 810 provides the user the ability to review the impact with respect to the construction details.

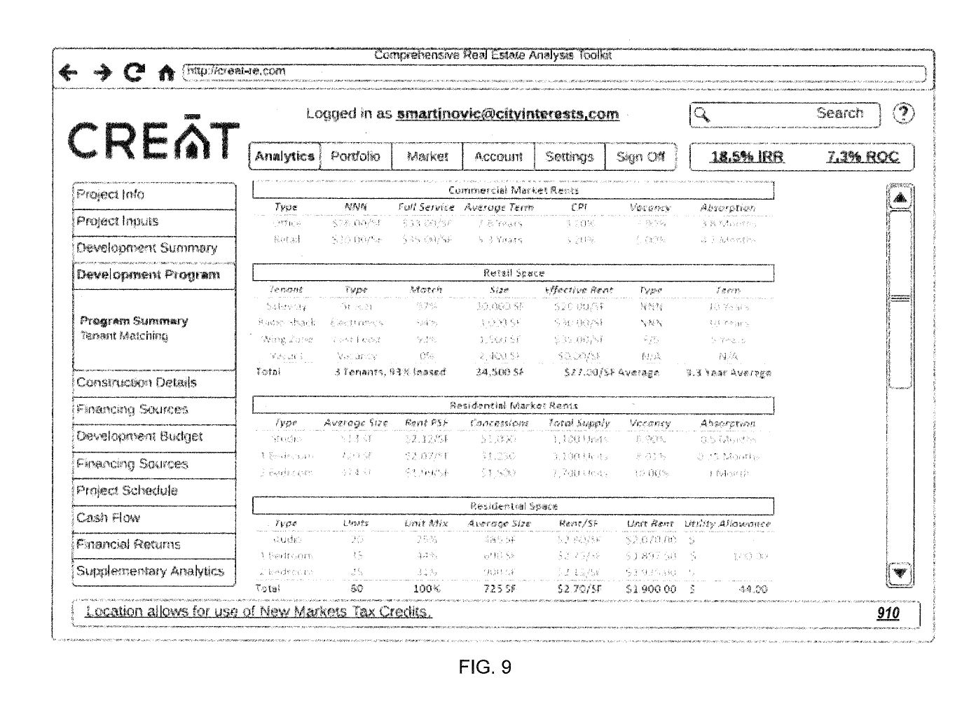

FIG. 9 is a screen shot of an example user interface that shows a program summary of tenant matching for a real estate development project. One aspect of the development program that is used to more accurately project base building costs is the programming of various land use types, which determines construction costs. In addition, programming of the various land use types can drive the operating pro forma and cash flow models, which can be a key component of the analytic platform. Across all product types, the user is able to input the mix of project uses as rentals versus sales (e.g., a condominium) and what level of affordability and income restrictions, if any, are applicable to each project use. For retail and office uses, the program can be determined by the anticipated project tenants and their assumed space needs. Tenancy projections can be determined by the demographics and location of the site as well as the availability of related services in proximity, as to take advantage of gaps in services and prevent leakage. For hotel uses, the program can be determined through a synthesis of prevailing local market hotel program trends as well as the flag/type standard for the anticipated hotel brand. For residential projects, the program includes the determination of both the unit type mix/allocation and size of different unit types, both of which are derived from a survey of comparable properties in proximity to the project. Inclusionary zoning can be considered for multifamily properties to the extent that it is required by local jurisdictions. For residential projects with an affordable housing component, the allocation and subsequently the level of affordability of income-restricted units can be determined by a survey of comparable affordable properties as well as the minimum thresholds outlined by the financing structure and local government mandated inclusionary zoning requirements. The user can specify a number of comparable properties from which to draw comparisons. Comparable properties can include same product types and can be filtered and weighted based on their attributed similarity distance from the target property. To the extent possible, the Fannie Mae Uniform Appraisal Report form can form the basis and allow for adjustments to the baseline in comparing comparable properties to the target. In addition to surveying properties in close proximity to the target project, the user will be able to monitor the velocity of building activity in the area through a graphical display of building permit activity. When any changes to project assumptions that have an impact on other assumptions in the analytic platform occur, a notification bar 910 provides the user the ability to review the impact with respect to the development program.

Development Budget

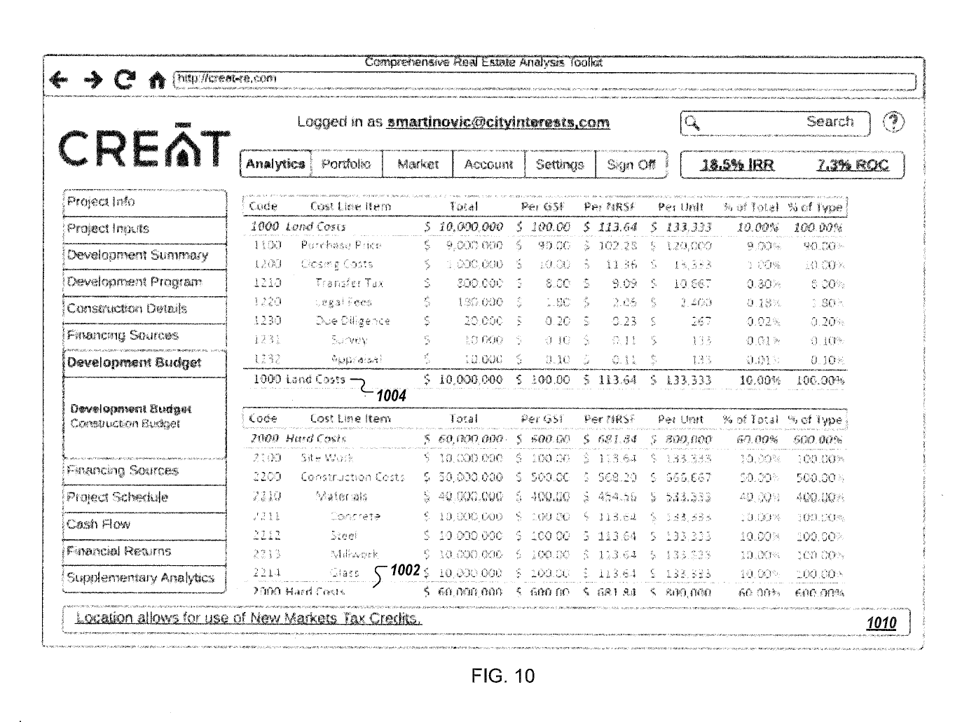

FIG. 10 is a screen shot of an example user interface that shows a development budget for a real estate development project. A development program (development program 310) and user adjustments can result in a building program that can be synthesized with construction cost data. Pertinent construction costs can be derived through a synthesis of building size, construction type, use, and location. Construction and foundation type can be determined by building size, land use, soil composition and water table. As determined by geotechnical and structural engineering best practices, structure and foundation-specific construction cost data can result in a calculation for total base building costs. Base building costs can then be adjusted to account for adaptive reuse of existing structures, wage premiums, historical preservation considerations, green building standards, and level of finish. Adaptive reuse of the existing structures can be calculated based on the condition and construction of the existing structure, a percentage of the gross building area in concert with the scope of reuse. Existing site conditions are captured through the Computer Assisted Mass Appraisal (CAMA) methodology and provide the user insight as to the condition and build quality of the in-place structure. Through study of the existing conditions, a populated assumption as to the anticipated level of adaptive reuse of the existing structure can be provided.

Wage premiums can be determined by the building size, selection of financing sources, and the market in which the project is located. Historical preservation considerations can be determined by the age of the structure in concert with the status of the property's location in a designated historic district. Green building considerations can be determined by the land use, local guidelines, financing structure, and a survey of comparable properties. Level of finish can be determined by demographics, land use and a survey of comparable properties. The CREĀT can provide an in-depth breakdown of base building costs to the user in order to clarify the rationale behind the total base building cost figure. When any changes to project assumptions that have an impact on other assumptions in the analytic platform occur, a notification bar 1010 provides the user the ability to review the impact with respect to the development budget.

In addition to base building costs, there may be additional budget line items that include an overall project hard cost number, including site work, general conditions, sheeting and shoring, environmental remediation, completion and other bonds, insurance, construction management fees, design contingency, and developer contingency. Site work can be determined by the land area, construction type, building size, and existing site conditions. General conditions can be determined through market surveys of general contracting firms and are calculated as a percentage of the adjusted base building costs. Sheeting and shoring and environmental costs can be determined by the existing environmental conditions, development program, and below grade space, as the volume of soil to be excavated, disposed of, and shored is the main cost driver. Bonds, insurance, and construction management fees can be determined by market convention, the project's costs basis are calculated as a percentage of the construction costs. Design and developer contingencies can be determined by market convention and can be calculated as a percentage of construction costs and are in place to mitigate the risk associated with cost overruns in the construction stage of the development. If costs are input that exceed the prior number, the CREĀT can prompt the user with an option to deduct the overage from the contingency.

For hotel uses, furniture, fixture and equipment costs as well as costs related to the procurement and installation of technology systems such as a private branch exchange (PBX) system and security can be determined by a survey of comparable hotel projects in the area as well as the flag/brand standard. The user can also input custom line items associated with any hard, soft, land, or financing costs and can provide insight as to the distribution of the cost as it relates to the schedule. By combining the base building costs with the other hard cost line items, the CREĀT can provide a projected total hard cost number 1002 for the project, which can be incorporated into the overall project budget (e.g., development budget 322).

Soft costs are included in the next section of the project development budget and can include, but are not limited to, architectural and engineering, legal, tenant buyout expenses, landlord and tenant space improvements, leasing commissions, developer fees, taxes (or payment-in-lieu-of-tax (PILOT)), consultant fees, permitting and inspection fees, utility connections, and contingency. Architectural and engineering fees including structural, civil, geotechnical, and mechanical, electrical & plumbing (MEP) can be determined by the complexity and scale of the project as well as the level of finish and design constraints. Legal fees can be determined by the applicable entitlement process, financing structure chosen, and various other project complexities. Buyout expenses are applicable in the event that the development program requires the relocation of in-place tenants or termination of leases. For office and residential tenants, buyout expenses are determined through the application of per square foot relocation expenses to the total square footage leased by the various tenants. Buyout expenses for retail tenants can be determined by the projected profits foregone by retail tenants during the construction period as calculated through a synthesis of anticipated sales per square foot and margin for the retail tenant types, total square footage leased by respective tenants, and the construction duration of the project.

Landlord work and tenant improvement costs can be determined by tenant selection, comparable leases and the size of the project's commercial component. Leasing commissions can be determined by comparable market rents respective of tenant selection and market convention of commission rates in the project area. Development fees can be determined by market convention, the financing structure chosen, and user input for integration of the developer's company fee structure, and is calculated as a percentage of project costs.

Taxes (or PILOT) can be determined by the tax rate structure outlined by the government tax agency presiding over the project location as well as the existing tax treatment based on the project's existing conditions and assessment. If tax abatement is applicable to the project, the user can input the level and term of abatement. Consultant fees for services such as market studies can be determined by market convention as well as the project financing structure. Fees for permitting can be determined by the presiding permit issuance authority as well as the scope and land use of the project. Testing and inspection fees can be similarly determined, and can also be influenced by the project's environmental conditions. Utility fees can be determined by the various utility authorities providing service to the project as well as the scope and land use. Soft cost contingency can be determined by market convention, can be calculated as a percentage of soft costs and is in place to mitigate the risk associated with soft cost overruns. Through analysis and synthesis of all of these data points, the CREĀT can provide a projected total soft cost number for the project, which can be incorporated into the overall project budget.

Land and acquisition costs are included in another aspect of the project development budget and can include a purchase price, acquisition related consultant fees, acquisition and due diligence legal fees, transfer and recordation taxes, and other closing costs. The purchase price can be determined by the amount of buildable area permitted per entitlement and a survey of comparable transactions. Acquisition-related consultant fees for services such as assessments can be determined by market convention as well as the project financing structure. Acquisition and due diligence related legal fees can be determined by the scope of the transaction and market convention for derivation of rates. Transfer and recordation taxes can be determined by the tax rate structure outlined by the local government presiding over the project location. Other closing costs can be determined by the purchase price and market convention for related fees. In the event of a land lease, which can be selected by the user, the expense related to the land lease can be determined by a survey of comparable land lease transactions in proximity to the project site and is prorated on a per square foot basis in being applied to the land area of the subject property. By compiling these pertinent land and acquisition costs, the CREĀT can provide a projected total land and acquisition cost number 1004 for the project, which can be incorporated into the overall project budget.

The pertinent construction costs, hard costs, and soft costs can then be combined to provide a projected total development cost for the real estate investment project.

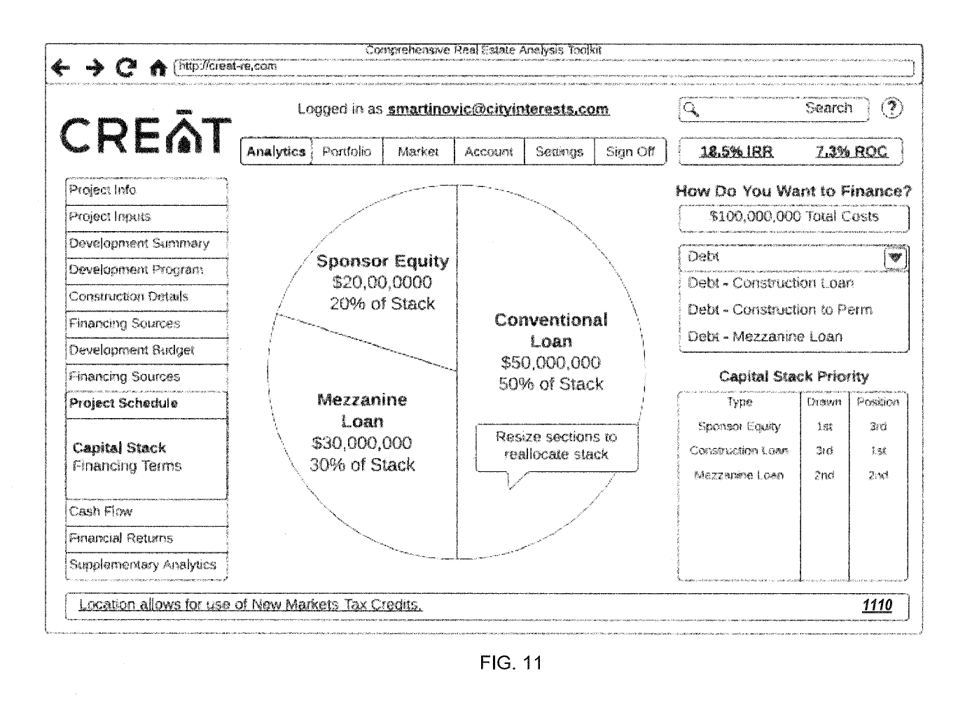

FIG. 11 is a screen shot of an example user interface that shows a capital stack of financing terms for a real estate development project. In some implementations, the CREĀT can compile financing costs which are an important component of the development budget. The financing costs include, but are not limited to, origination and application fees, issuance costs, mortgage insurance premiums, and reserves. The origination and application fees, issuance costs, and mortgage insurance premiums can be dependent on the project financial structure. Construction interest reserves can be determined by the components of project's financial structure and their respective terms in concert with the project schedule. The capacity and mix of financing sources can be determined by terms available in the market based on the project's location and use as well as user input as to the timing of contribution and pecking order of funds. A survey of market terms can yield an outline of constraints with which the capacity of each tier of financing is sized. Aside from construction interest reserves, the lease-up, operating, and replacement reserve line items can also be determined by the project's financial structure along with projected absorption, operational cost projections, and life cycle replacement costs, respectively. With the financing line item costs populated, the CREĀT can include a total financing cost number for the project. The final consideration inherent in budget formulation can be the impact of inflation/escalation. Inflation/escalation can have an impact on construction costs as well as operating revenue and expense projections and can be determined by the forecast inflation as indicated by the consumer price index as well as the project schedule and distribution of cost incursion. With these data points, the CREĀT has completed the budget and development program along with a development budget report. When any changes to project assumptions that have an impact on other assumptions in the analytic platform occur, a notification bar 1110 provides the user the ability to review the impact with respect to the project schedule.

Operating Pro Forma

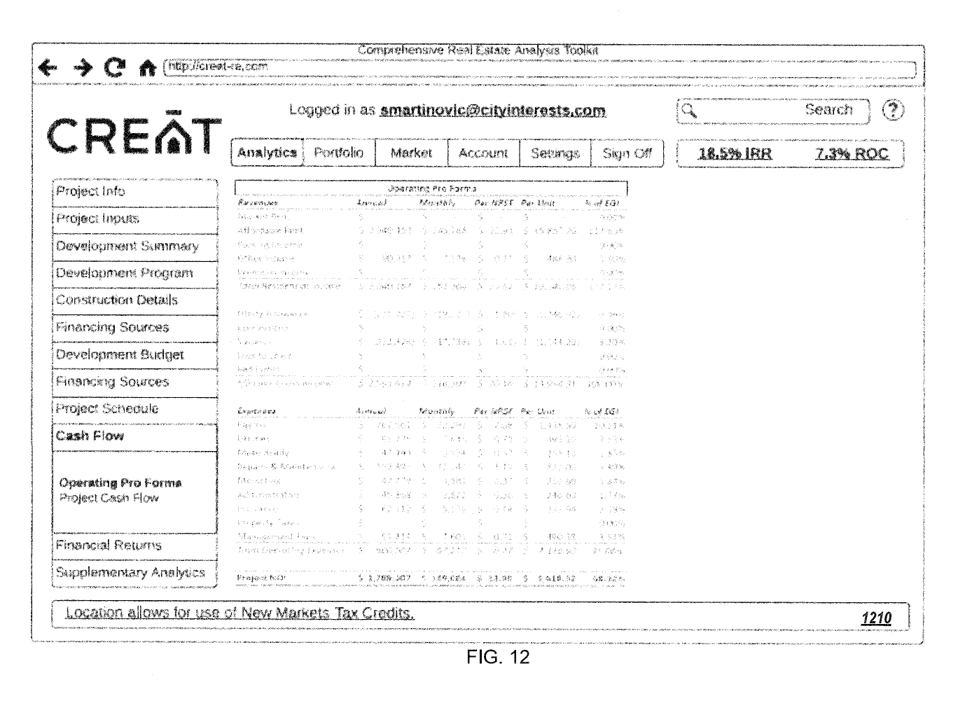

FIG. 12 is a screen shot of an example user interface that shows revenue and expense projections in the form of an operating pro forma for a real estate development project. Referring to FIG. 3, once the budget and development program is in place, the CREĀT can generate an operating pro forma (operating pro forma 312) and cash flow (project cash flow 314). The pro forma can include, but is not limited to, income from sales and/or rentals, income from ancillary functions, vacancy, credit loss, utility and other allowances, concessions, expense recoveries, fixed and variable operating expenses, operating and maintenance reserves. Rental income can be determined by the total net rentable space derived from the development plan and market rents for each use type. Comparable market rent for each use type can be determined by a survey of rents from comparable properties of the same type and can be applied on a prorated basis to the project's development plan. If certain uses in the development program are sold rather than rented, sales metrics can similarly be determined by a survey of comparable sales, adjusted to account for tenant selection, and applied on a prorated basis to the project's development plan. When any changes to project assumptions that have an impact on other assumptions in the analytic platform occur, a notification bar 1210 provides the user the ability to review the impact with respect to the cash flow.

For hotel uses, revenues can be determined by a survey of comparable hotel properties' average daily rates and occupancy and are benchmarked against a comparable revenue per available room (RevPAR) index. Ancillary hotel revenue streams such as food and beverage can be similarly determined by a survey of comparable hotel properties. Income from other building uses such as antennae or billboard/signage rent can be input by the user based on the specifics of the project. Vacancy and credit losses can be determined by actual vacancy rates in the project location, respective of use type and building class. Utility allowances for affordable units can be determined by the project jurisdiction's public housing agency (PHA) and/or Department of Housing and Urban Development (HUD) schedule. Concessions can be determined by a survey of comparable properties. Expense recoveries can be determined by the project's operating expenses and tenants' lease structures as they pertain to pass-through expenses.

Operating expenses can include both fixed and variable operating expenses, and can include management fees, leasing and marketing, salaries, administration, maintenance, utilities, insurance, real estate and Business Improvement District (BID) taxes (or PILOT), and make ready costs. Management fees can be determined by market convention for product type and gross revenues from the project. Leasing and marketing expenses can be determined by the development program and market convention. Salaries, administration, maintenance, and make ready costs can be determined by the development program and a survey of similar expenses in comparable properties. Utilities can be determined by the financing structure, development program, unit mix, and LEED certification level. Taxes (or PILOT) can be determined by the tax rate structure outlined by the local government presiding over the project location as well as the existing tax treatment based on the project's existing conditions and assessment. Hotel uses can also include operating expenses for lodging, food and beverage, and other revenue streams determined by a survey of comparable hotel projects and are calculated as a percentage of those revenue streams. Operating and replacement reserves can be determined by the financing requirements, development program, land use, and project life cycle. By synthesizing the revenue and expense data, the CREĀT can complete an operating pro forma report, resulting in bottom line projections for net operating income.

If desired, the user has the flexibility to input specific lease parameters through either a selection of various lease attributes or through text recognition functionality. Lease attributes can include, but are not limited to, size, base rent, escalation, term, lease type, and renewal options. These and other pertinent lease attributes can be populated by user input using a user interface or by text recognition. In some implementations, development stakeholders may be required to undertake the onerous task of manually inputting and overlaying a variety of lease attributes. In implementations that include the CREĀT, the input of lease attributes can be simplified into one cohesive action. Though commercial real estate leases can be complex, in most cases, a commercial real estate lease can be described in brief. For example, an analyst may previously have spent valuable time inputting known lease particulars, whereas the CREĀT can analyze simple text such as “Tenant A has a 10,000 SF 10-year lease at $15/SF NNN base rent adjusting annually at CPI with a 5 year renewal option.” (NNN is triple net lease, SF is square feet, and CPI is consumer price index.) While rich in information, the content can be uniform enough where the CREĀT can interpret the key points and format the key points for integration into the analytic model.

Project Schedule

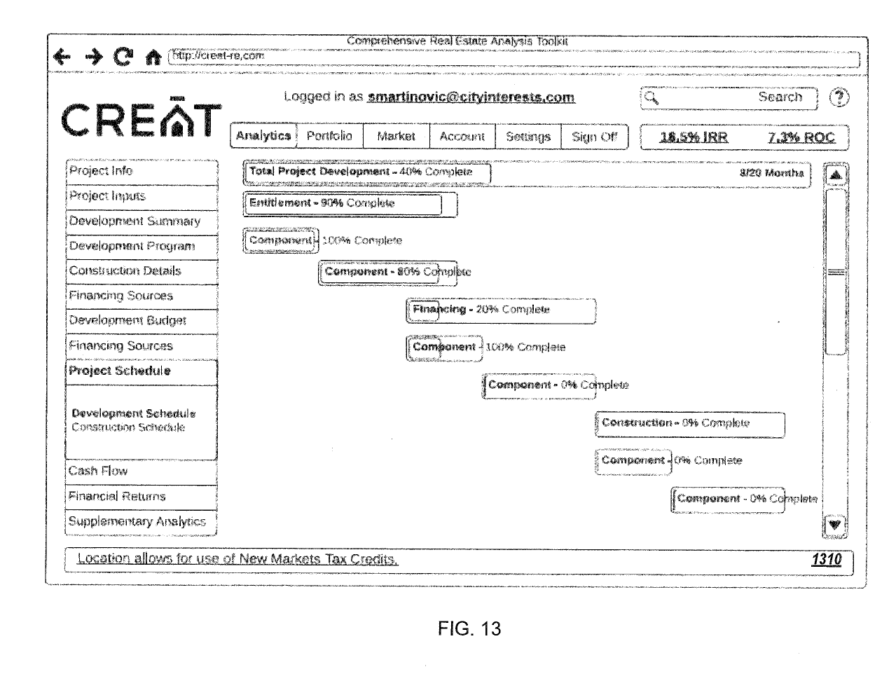

FIG. 13 is a screen shot of an example user interface that shows a development schedule for a real estate development project. A project schedule (e.g., project schedule 320) can be a key component in the analytic output provided by the CREĀT. The project schedule can include, but is not limited to, acquisition, predevelopment, construction, and hold periods or phases. The acquisition phase can be determined by the project size and financing structure. The predevelopment phase can include schematic design, design development, construction documents, entitlement, and permitting. The schematic design, design development, and construction documents phases can be determined by the project scope, construction type, and development program. The entitlement and permitting phases can be determined by the local zoning and permitting processes and the proposed development program as it compares to the baseline current zoning conditions and by-right scenario. The construction phase can include demolition and site work, foundation installation and below-grade work, framing, mechanical, electrical and plumbing, insulation and drywall, exterior and interior finishes, and tenant fit-out. Demolition and site work can be determined by the development program, the existing conditions of the site, and the level of adaptive reuse. The foundation and below grade phase can be determined by the type of parking, development program, and type of foundation. The framing phase can be determined by the development program and the construction type. The mechanical, electrical and plumbing, and insulation and drywall phases can be determined by the development program. The exterior and interior finish phases can be determined by the building shape, the development program, and the level of the project's finishes. Tenant fit-out can be determined by the amount of tenant improvements, the tenant mix, the development program, and the level of interior finish. The hold period can be determined by user input as to timing of exit or recapitalization strategy. When any changes to project assumptions that have an impact on other assumptions in the analytic platform occur, a notification bar 1310 provides the user the ability to review the impact with respect to the development schedule.

In some implementations, some of the project phases overlap and some of the project phases can be dependent on other project phases to complete before initiation. By synthesizing the components of the development phasing, the CREĀT can compile a project development schedule. Progress can be tracked throughout the development process and can be iteratively updated as schedule adjustments occur. For example, progress tracked at a high level in Gantt chart format can include an indication of where the project currently stands relative to each phase of the schedule. The CREĀT tracks the project's progression along several different timelines to gauge the achievement of milestones in relation to entitlement, financing, and construction. With this, the CREĀT has now completed the project development schedule.

In addition to tracking the development's status throughout the project life cycle, the CREĀT also aids the user by formulating a list of recommended next steps as it pertains to consultant engagements and regulatory compliance such as obtaining entitlement approval and permits. This recommended sequence of events can be presented in a list format and can be generated by extracting relevant data points from the overall project schedule. This sequence provides the developer with a clear path to successful project execution by bettering time management practices in order to continuously further a project's momentum to meet schedule benchmarks throughout the development process.

Project Financing Sources & Uses

Referring back to FIG. 11, the user interface can show a capital stack of financing terms for a real estate development project. The CREĀT can determine the use of funds and expenditure schedule for the project. In order to generate a full project cash flow, the sources of funds (financing sources and users 216) must also be identified. The CREĀT can initially populate the financing inputs with the market sizing convention for a construction loan with the balance of funding represented as equity. The user can choose from a variety of different financing types and can incorporate their selections into an overall capital stack. The capital stack can include, but is not limited to, equity, debt, and subsidy financing sources. Equity can include developer equity, sponsor equity, and land equity. The amount of equity that the project can support from a required return perspective can be dependent on the type of equity invested. Developer and sponsor equity can be determined by the required return for an equity investment given the project's risk premium for use and location as well as the prevailing risk free rate. Land contributed to the project as equity can be valued by the amount of buildable area permitted per entitlement and a survey of comparable transactions. Equity investment in the property can be structured as a joint venture with a waterfall return structure and preferred return. The user can input any number of project return hurdles and cash flow splits between any number of joint venture partners that the user specifies. When any changes to project assumptions that have an impact on other assumptions in the analytic platform occur, a notification bar 1410 provides the user the ability to review the impact with respect to the capital stack.

The debt portion of the capital stack can include, but is not limited to, acquisition, construction, construction-to-permanent, participating, land, and mezzanine loans. The sizing of all of the different loan types can be determined by lending market surveys of the loan-to-cost, loan-to-value, and debt service coverage ratios as well as total term and amortization periods required by lenders for the given project type and location for each respective type of debt. The applicable interest rates for the project can be governed by the anticipated time to either rate lock or closing, as the benchmark rate to be applied to the project which the effective rate is derived from, is subject to interest rate risk in the time between when the project is initially modeled and when financing terms are locked in. As a result, forward rate projections can be used to determine the appropriate interest rate for various pieces of financing that comprise the debt portion of the capital stack. This can be particularly true of fixed-rate debt financings, though floating rate financing is an option which may be selected by the user as well. In addition to these capacity constraints, in the case of participating loan financing, the user can input the degree of cash flow participation that has been structured. If no permanent debt is included in the capital structure that the user has input, the CREĀT will assume a conversion of any temporary debt to permanent debt at par, to the extent that the level of temporary debt is supported by the capacity of the permanent financing.

The subsidy financing portion of the capital stack can include, but is not limited to, Tax Increment Financing (TIF), Low Income Housing Tax Credits (LIHTC), EB-5 financing, Housing Factor Replacement Funds, New Markets Tax Credits (NMTC), HUD 221(d)4, Hope IV, HOME, Community Development Block Grants (CDBG), Housing Production Trust Fund (HPTF), Neighborhood Stabilization Program (NSP), industrial and other revenue bonds, and credit enhanced bond financing. Tax Increment Financing can be determined by the baseline real estate and sales taxes generated by the property, the future real estate and sales taxes generated upon project completion, and a market survey of the value of placement of the bonds in the market. Low Income Housing Tax Credits can be determined by the allocation of affordable units, eligible costs from the project development budget, the type of tax credits inputted by the user (e.g., 4% vs. 9%), eligible basis boost determined by the project's census tract, and the syndication value of the tax credits in the market given the project's location. EB-5 financing can be determined by the total permanent and long-term construction job creations that the project generates. HUD 221(d)4, other credit enhanced bonds, and industrial revenue bond financings can be determined by lending market surveys of the loan-to-cost, loan-to-value, and debt service coverage ratios as well as total term and amortization periods required by lenders for the given project type and location for each respective type of debt. Housing Factor Replacement Funds, Hope IV, HOME, New Markets Tax Credits, Community Development Block Grants, Housing Production Trust Fund, and Neighborhood Stabilization Program funds can be determined by competitive application to either local, state, or federal jurisdictions for allocation.

With the calculation of the financing assumptions and input from the user, the CREĀT has the components of the project capital stack. The different equity, debt, and subsidy components can be dragged by the user to reorder them to represent the sequence as to which funds are drawn from the various sources. If the project cannot be supported by the amounts of the financing components, the user can either override the suggested constraints or a gap funding component will be represented in the capital stack. With the allocations amongst funding sources and the sequence of their draw set, the CREĀT has formulated a capital structure which can be shown in a sources and uses report. In the instance of certain types of tax credits, it is possible that future rounds of tax credit funding may be available to the project after certain periods of time to fund renovations to the property. These subsequent financing rounds can be determined by the financing vehicle(s) used to fund the project and the projected cost of renovations or project improvements as determined by the development program and the useful life of the project as dictated by the construction type and land use.

Project Cash Flow

By combining a minimal number of user inputs with a knowledge base of industry best practices, real-time data, and decision tree logic, the CREĀT has formulated a development summary, project budget, operating pro forma, project schedule, capital structure/sources and uses report. The combination of components from these different reports can be channeled to create an overall project cash flow. The project schedule can drive the distribution of the different budget line items to accurately reflect the incursion of project costs over the development phase of the project. The project schedule can also drive the initial operating income and expenses and their respective escalation over the hold period of the project. The phasing in of capital, repayment of project financing and exit timing can also be reflective of the project's schedule. With the linking of the project schedule to all cash inflows and outflows, an overall cash flow from inception through disposal can be formulated. The exit strategy can be defined by user input and includes sale, refinance, and the discounting of perpetual cash flow terminal value as options. At this point, the CREĀT has produced a full development and operation cash flow, the most comprehensive and critical piece of the analytic output.

Scenario Analysis

In some cases, the rationale behind the computation of a particular assumption can be subjective. In order to mitigate the risk inherent in these variable assumptions, the CREĀT may not return one definite measure for each return metric, rather, the accuracy of the analysis can be enhanced through the practice of Monte Carlo simulation. This scenario analysis can represent a normally distributed range of values for each subjective assumption and can randomly sample values within the range to formulate a probability distribution of project returns. The CREĀT can do this for every subjective assumption not yet defined by the user. Rather than provide the user with a static return metric, the CREĀT can allow the user to gauge their appetite for the project by analyzing all potential outcomes given CREĀT assumed and user inputted data. As the project progresses through its life cycle and the user is able to input more real world data in lieu of the assumptions, the quantity of variables which are included in the Monte Carlo simulation decreases. As a result, the CREĀT can present a narrower range of returns with a higher degree of statistical significance. Referring to FIG. 6, the full return distribution 602 is accessible to the user and can be tracked over the project life cycle, while a continuously updated indicative gauge of investment performance is available for reference on all interface screens (e.g., gauge 604). In addition to assessment of the range of anticipated project returns, the user can display comparative returns of the target property and other properties in proximity for the specified or optimized use type in the form of a heat map of returns. A heat map indicating areas of relative investment performance can be generated through the analysis and comparison of properties in proximity to the target project. The user-selected metric of investment performance displayed on the map can be limited to the analysis of either a user-defined specific use type or an optimized use type across all properties to be analyzed.

Project Physical Analysis & Renderings

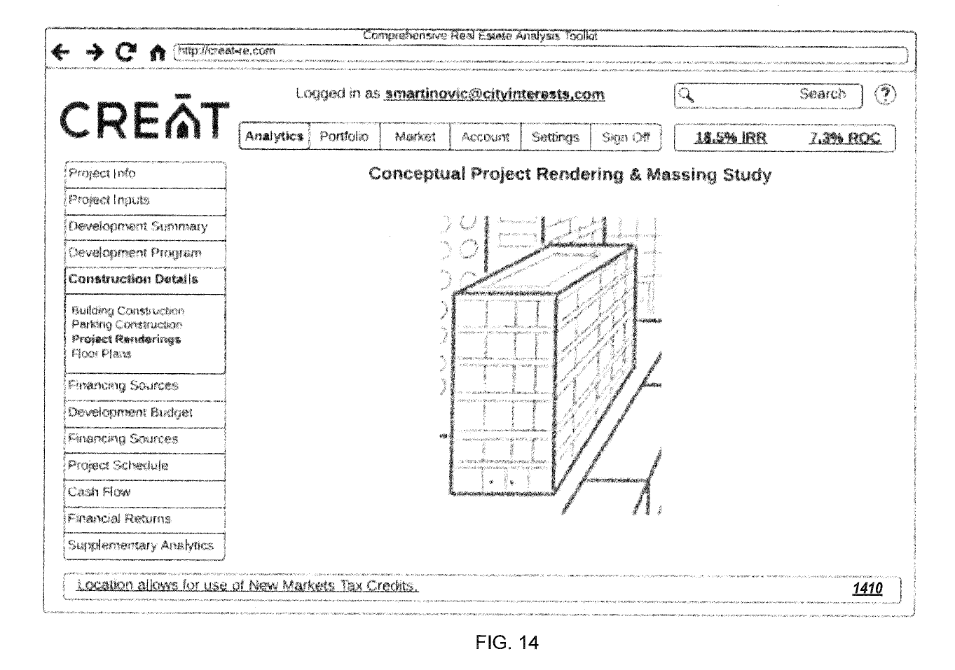

FIG. 14 is a screen shot of an example user interface that shows a conceptual project rendering and massing study for a real estate development project. In addition to the financial analysis of a development project, the CREĀT can capture design and physical elements necessary to formulate a qualitative analysis of the project. With the physical attributes of the building as well as the construction type and material selection, the CREĀT can produce a basic rendering of the project superimposed over the selected project site. The baseline CREĀT-assumed shape of the building can be determined based on the size of the building footprint within the shape constrained by the lot lines of the user-defined parcels. Within the boundaries of the selected parcels, the CREĀT can assume that the structure can be positioned as close to the busiest (based on traffic counts) public street fronting the project as possible while still adhering to the zoning-mandated setback requirements. This shape can be used as a baseline, with a drawing interface incorporated to allow for user adjustments to the building footprint dimensions. The footprint shape is given mass determined by the development scheme in respect to the number of stories, floor to floor height, and overall building height as well as the type of parking employed. The structure is then clad in exterior finishes by the building construction type parameters outlined in the development summary. In the case of the incorporation of existing structures, the shape of the structure can be discerned from an analysis of aerial photographs of the site and the cladding and façade treatments can then be true to life, as imagery can be integrated from street view photography of the project. Floor plate sizing relating to projects that maintain the core and shell of the existing structure can be determined through the survey and application of as-built floor plans for target buildings for which they are available. Floor plan layouts can be determined through the application of basic architectural principles in light of the use or mix of use types selected then applied to the dimensions of the floor plate. As a result, buildings can be rendered both inside and out through the aid automated space planning analysis and algorithms, and thus individual properties and subsequently entire cities and be optimally planned and visualized. This provides the user, particularly the government user, with guidance on how to maintain the consistency of architectural vocabulary of an area through the qualitative model while determining how to best deploy economic incentives to accelerate development in order to aid in execution of the city's comprehensive plan.

When any changes to project assumptions that have an impact on other assumptions in the analytic platform occur, a notification bar 1410 provides the user the ability to review the impact with respect to the project renderings.

At this point, the CREĀT has created a 3D model/massing study of the development project. Just as in the financial model where the user or other development stakeholders can iteratively update assumptions to more accurately reflect the current stage in the development life cycle, the same is true of the project design. Prior to architect input, the user can make adjustments to the building layout and to have any assumptions impacted by the design changes instantly reflected in the financial analysis. When architectural design is refined by the architect or another consultant, the CREĀT can provide the ability for integration of CAD renderings which represent the project's physical attributes along with the accompanying changes made to the project assumptions. The completed rendering can be integrated with existing 3D modeling software in order to gain insight as to the project's physical characteristics in the context of the site's location and surrounding properties. This qualitative analysis can be particularly useful in design charrettes, zoning adjustment hearings, and community meetings and is useful to consultants to aid them in their ability to put together more accurate bids on the project. This qualitative analysis can also be included with the financial analytic package to submit to banks and other financial Institutions to aid in their underwriting processes and to governments in order to help frame RFP responses.

Supplementary Project Analytics

In addition to the core collection of reports that the CREĀT assembles, the user can access other supplementary reports that can be incorporated in the analytics package (e.g., physical analytics 224). The supplementary reports can include residential end-user purchase breakdowns, job creation analysis, sales and property tax impact analysis, an economic impact study, an overview of site-specific data points, area demographics, sensitivity analysis, cost variance analysis, and an overview of the development pipeline in proximity. Residential end-user purchase breakdowns can model the cost to the purchaser of a residential for-sale property given a variety of convention consumer financing structures including traditional mortgage, federal housing authority (FHA) mortgage (if eligible), and local subsidy financing programs (if eligible) in both absolute dollar terms and as a percentage of area medium income (AMI). The output of the purchaser breakdown can be determined by the financing programs available in the project region, the prevailing interest rates and amortization periods available given the chosen financing structure, and the purchase price of the residential unit. Job creation analysis is a determinant of EB-5 financing proceeds and can be determined by property type, development program, a study of employees per square foot for various use types for full time equivalents (FTE), and labor requirements for on and off-site construction of the project. Sales and property tax impact is a determinant of tax increment financing (TIF) and can be determined by the baseline and future real estate and sales taxes generated on project completion as outlined by existing property and sales tax revenues as well as metrics on average sales per square foot for different retail use types at the project location. Site-specific data points such as property owner, school district, sales history, and other pedigree information can be available for review by sourcing information from local government resources and tax records. Area demographics can determine tenant selection and can be broken down by Census Tract and accessible, for example, through the US Census Bureau FactFinder database. Sensitivity analysis can be performed in the background of the analytic model and can be driven by a Monte Carlo simulation. The distribution of the analytic results can be available to the user in a report which allows the user to view and interpret the range of potential project outcomes in addition to the average outcome. Variance analysis can be derived from the initial log of project assumptions as it compares to values which the user has input since inception. This can allow the user to analyze how the baseline expected return compares to the project in its current state by tracking the distribution of returns throughout the project life cycle.

Market Portal

Once the analytic package is assembled, it can be exported in a spreadsheet format or into the market portal (market portal 218). The market portal can allow for portability of project analytics in a consistent, standardized format and can provide a vehicle for interfacing with and transmitting data to potential project stakeholders. By expediting the flow of information between users, the CREĀT can facilitate more efficient project underwriting while the analytic package's accompanying change log can promote transparency and more effective risk management practices. The development and collaboration process can be streamlined, allowing the user to more easily take projects from concept to completion. Each user of the CREĀT can customize their own profile page to detail their personal background, the background of their company, the projects they are currently working on, the projects they have completed in the past, and their contact information. Users' individual profiles can be linked to that of their company through the domain name of the email address they used when registering their account. By populating these attributes, the user allows others in the industry to assess their expertise and learn about their skill sets.

Users can post project analytic packages they have created in order to solicit co-development interest from other users in a forum listing format which is searchable by a variety of attributes such as total cost, investment required, projected return, use type, and project location. Users can team with developer users of the CREĀT to diversify project holdings while limiting risk exposure, reducing capital outlay, and tapping into areas of expertise of other users. Search and filtering functionality can allow other users, including developers, financial institutions, and other stakeholders to pre-screen publicly shared projects and display only results that meet their desired scope, investment objectives, or other criteria. The users can provide feedback to the developer users regarding the costs associated with each posted project analytic package. The feedback can be provided in one or more formats that can include an absolute dollar basis, a dollar per square foot basis (PSF), a per unit basis, or other type of prorated basis. In addition or in the alternative, the users can provide non-cost related feedback to the developer users that can be related to attributes of the project such as unit count and construction type.

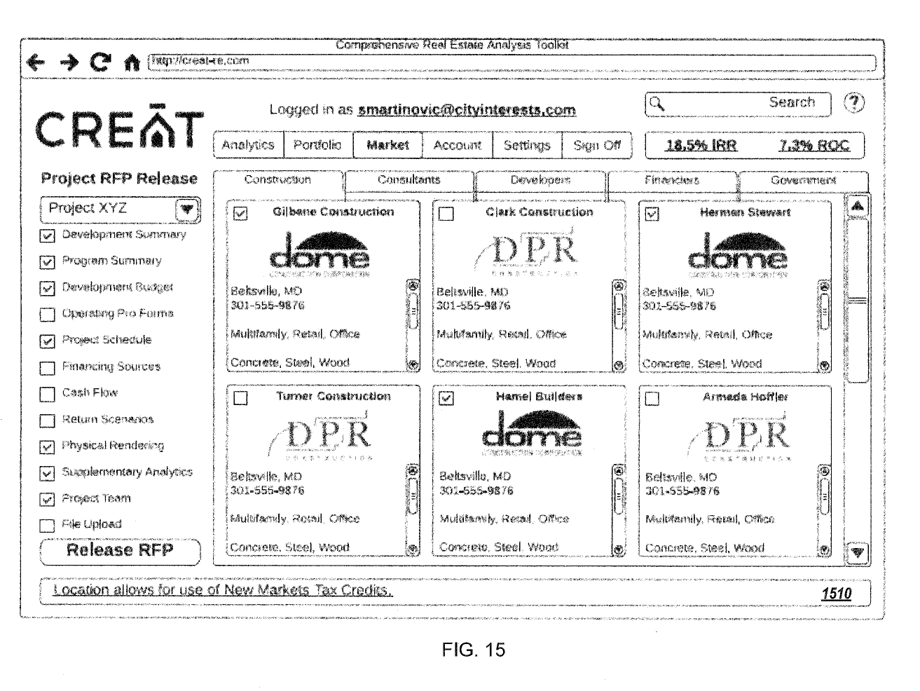

FIG. 15 is a screen shot of an example user interface that shows construction contractors filtered by areas of expertise pertinent to the real estate development project being analyzed. In addition to a forum where users can interact with one another, when the user logs into the market portal component of the CREĀT, the user can search various categories of project stakeholders and can choose those they would like to interact with, including banks and other financial Institutions, general contractors, government agencies, and consultants. In addition, in the example of FIG. 15, the user can select what aspects of the project RFP they would like to release to the selected project stakeholders for review. In the instance of banks and other financial Institutions, the user can provide customized financing quotes and preliminary underwriting terms based on the project specifics contained in the analytic package. The accompanying log of changes in assumptions allows these financial institutions to manage their risk more effectively by comparing the CREĀT-populated baseline assumptions which are market-driven with the modeled assumptions submitted by the user. Construction companies and project consultants can similarly use the analytic package to assess the scope of work required to formulate and submit bids to provide services for the project. The project details can allow these stakeholders to streamline the bid preparation process by mitigating the need for research and data collection, reducing the analytic burden and thereby driving price competition in the marketplace. A notification bar 1510 provides the user with additional details relevant to the construction contractors that may also be relevant to the real estate development project.

Government agencies can use the market portal to interface with developers in order to receive and process necessary permit filings and to release requests for proposals for public-private partnership development opportunities. Based on the desired project outcome, agencies can program in constraints that users are bound by as they craft development proposals for parcels of interest. Users can then respond to the RFP by submitting an analytic underwriting package that marries the government's requirements with the developer's concept for a viable project. In all of these instances, responses crafted by any user type can be returned to the requesting user electronically with notifications made in an inbox format.

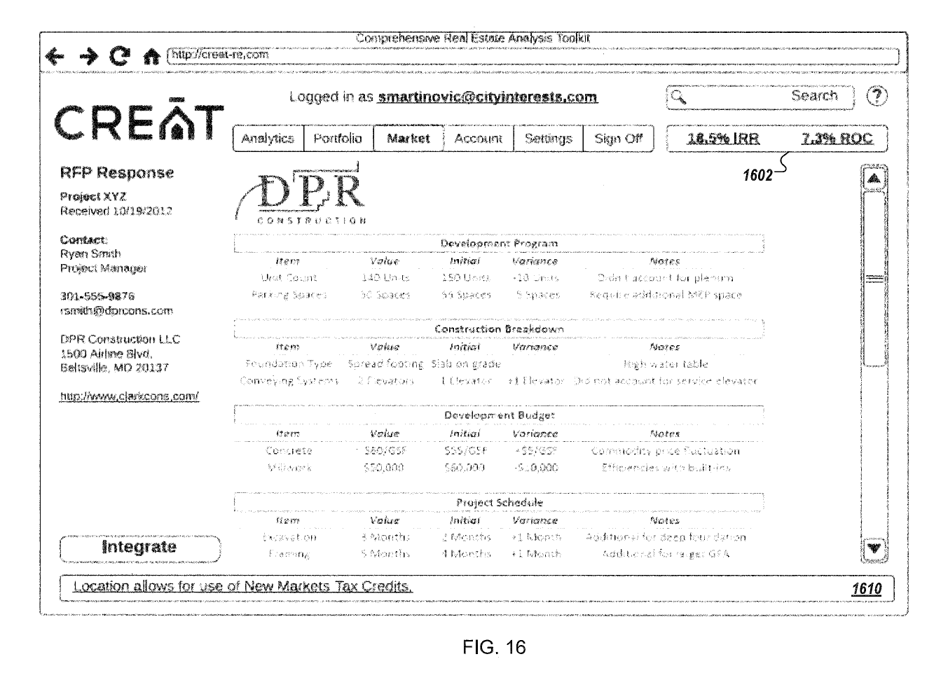

FIG. 16 is a screen shot of an example user interface that shows a response to a RFP (e.g., the example project RFP release shown in FIG. 15). Users of the market portal can use the analytic platform to analyze the project, and can craft their responses to the requesting user by directly inputting the affected assumptions into the model. To aid other market portal users in their assessment of a submitted project, the user can attach files that support assumptions the user has made in the analytic platform. The user can then keep track of relevant documents such as construction estimates and design documents and directly link them to line items in the project model. Other stakeholders can use these supporting materials to better understand the project and make an assessment as to their level of confidence in the user's development plan. Users can have the flexibility to share all information and supporting materials contained in the project analytic package or smaller subsets of the output in order to protect potentially proprietary information. Users requesting pricing information from other market portal users can have access to all of the bid data in an aggregated dashboard interface. The users can then compare and assess the impact of the price data and assumptions made by various respondents and can then choose to accept one of the bids and to have that bid's implications reflected in the analytic model. When a bid is accepted and integrated into the analytic model, the CREĀT also incorporates the accepted bidder's credentials into reports which show the project's development team. A notification bar 1610 provides the user with additional details with respect to the response to the RFP.

The market portal can be critical to compiling a pricing data warehouse. The market portal allows for progressively more accurate auto-populated assumptions as the CREĀT and data sets evolve over time. As users submit projects using the market portal to solicit bids from construction companies, consultants, and financial institutions, the pertinent data used to formulate the bid and the bid amount can be captured by the database anonymously. When new projects are submitted, the attributes of the new project can be compared with completed bids from other projects in the database. Based on the similarities and differences with those other projects, an estimated bid can be synthesized using real world bid data provided by firms and can be used to populate the appropriate assumptions.

Mobile Interface

In addition to a cloud hosted SaaS platform, the CREĀT can also be available, through a mobile user interface, to a user of a mobile computing device. While the navigation of the mobile user interface may vary slightly from that of a web interface, the functionality will be the same. The mobile user interface can allow users (e.g., project team members) to take the CREĀT into the field and update project assumptions in real time. The mobile user interface can allow users to complete field research with a portable analytic suite linked with geographic location functionality. When a user is in the field or otherwise accessing the CREĀT from a mobile computing device, the user can view and edit any of the same assumptions that the user can manipulate using the web interface. When the user makes an adjustment to an assumption using the mobile user interface, those changes are similarly logged and reflected in the analytic package in real time. In this way, changes that users make in the field are instantly reflected and viewable by other team members who have access to the project analytics.

The CREĀT's mobile user interface can leverage geographic location technology to form the basis of a field analyzer mode. The field analyzer can use the same comprehensive analytic platform as the web-based interface. The field analyzer can provide the ability for a user accessing the CREĀT through the mobile user interface to lock assumptions such as a desired use type and to select a project location as determined by the user's location based on their real-time global positioning system (GPS) coordinates. Through the field analyzer, the user can bookmark locations and link these saved locations with site photos taken with a camera included in the mobile computing device. While the field analyzer can provide access to the full analytic platform, the field analyzer can emphasize highlights from the design plan, development program, cost, revenue, and investment return projections to provide project insight at a glance.

Particular implementations of the subject matter described in this specification may be implemented to realize one or more of the following advantages. An automated analytic framework (e.g., CREĀT) can reduce the analytic and administrative burden imposed on real estate developers. By providing a consistent and accurate financial model, developers can save time that was previously spent programming new models while also eliminating the potential for human error in calculations or incorrect project assumptions. Given that the automated analytic framework can be linked to real-time data, developers can save time previously spent updating countless data points to ensure that projections are current. By synthesizing project inputs with an aggregated universe of pertinent data and a knowledge base of industry best practices, developers save time that was previously spent collecting and analyzing data. By providing instant access to project stakeholders, developers can save time that was previously spent engaging project consultants from a variety of industries for their expertise. Through a forum-based marketplace of underwritten investment opportunities, developers can save time previously spent sourcing new deals and vetting counterparties' underwriting assumptions.

In addition to the time saved by the reduced analytic burden imposed on developer users, additional efficiency can be gained through the automated analytic framework's ability to interface electronically with consultants and financing sources. The solicitation phase previously entailed research, the establishment of relationships, and a series of dialogues to eliminate any information asymmetry. In the case of responding to RFP solicitations, developer users can choose to lock particular assumptions into the analytic platform in order to restrict respondents from changing assumptions that are static or are subject to certain restrictions pertinent to the particular RFP. Financial institutions and consultant responses can be constrained in their formulation and returned to the RFP solicitor.

Much in the same way that the automated analytic framework adds value for developer users by streamlining project analytics, banks and financial Institutions can similarly benefit from a more efficient use of labor expenditures. In contrast to developer users who use the automated analytic framework to analyze projected financial returns, financial institutions can derive value by the implementation of more sound risk management in their lending activities. With the automated analytic framework's ability to use a Monte Carlo simulation to effectively model the project in nearly every conceivable permutation, financial institutions can better gauge where the areas of sensitivity are and can provide financing quotes that more accurately reflect the risk inherent in the project. In addition, the role of the financing originator can be made more efficient by directly linking the institutional user with developers and other clients actively seeking project financing through a portal (e.g., the market portal) that includes an interface that allows for portability of project analytics in a consistent, standardized format that also provides a vehicle for interfacing with and transmitting data to potential project stakeholders. Financial institutions can use the automated analytic framework to electronically receive pre-populated loan applications from applicants which can save on both analytic and origination labor. With the additional labor and capital available to the institution, the institution can then be redeployed in a manner which drives revenues, such as funding additional lending activities.

Consultants can similarly derive value by using the automated analytic framework through the portal, directly interfacing with other users who are in need of development-related services. Consultants can reduce their marketing and advertising expenses by having an interface with which to instantly solicit new business as well as to submit proposals to other users engaged in projects. The comprehensive analytic package provided by developer users to consultant users can reduce a significant amount of the project detail research a consultant would otherwise perform, enabling more accuracy and efficiency in bid preparation, and allowing the consultant to apply the labor savings towards driving profitability. Similar to financial institutions receiving pre-populated loan applications, consultants can use the invention to automatically populate fields in pertinent American Institute of Architects (AIA) and other industry standard contracts and documents.

Governments can derive value by using the automated analytic framework in a variety of capacities relevant to different agencies. Permit administration agencies can use the automated analytic framework to electronically receive pre-populated applications for permits and return fully processed permits to applicants. Economic development agencies can use the automated analytic framework to post, receive, and evaluate solicitations for development projects and government financing. In the case of RFP solicitation, government users can choose to lock particular assumptions into the analytic platform in order to restrict respondents from changing assumptions that are static or are subject to certain restrictions pertinent to the particular RFP. In this way, agencies can drive RFP respondents to operate within the constraints determined to be in the best interests of the project, its stakeholders, and the community. By comprehensively and efficiently communicating the details of an RFP governments can more effectively deploy resources that otherwise spent in the production and distribution of RFP solicitation materials and informational meetings to bring interested parties up to speed. This can free up more available resources and allow governments to provide better community outreach and to develop projects that bring the most benefit to the community.

The automated analytic framework can allow governments to more efficiently align their interests with that of the community and can provide the platform necessary to engage developers to execute on projects with the most civic impact. Governments can also solicit public feedback on proposals from RFP respondents. While not necessarily the sole tool for public engagement, the electronic format and breadth of information provided by the automated analytic framework can allow governments to synthesize relevant data points to inform community stakeholders. Area residents and organizations can be solicited for feedback more easily, as the automated analytic framework provides stakeholders with design and program information for projects that will have an impact on their community.

Project investment sponsors and retail investors can benefit from the use of an automated analytic framework through access to a marketplace of projects for potential investment. Previously, co-development and co-investment opportunities were largely sourced by professional networking, word of mouth, and placement through brokerage firms. While the automated analytic framework provides brokerage firms the opportunity to engage in investment placement and sourcing through the portal, it can also provide direct access for investors and project sponsors to connect in a transparent and efficient environment. The marketplace can provide a broader array of potential investments to investors while allowing developers and project sponsors access to a wider array of capital sources outside of the world of financial institutions. Smaller investors such as high net worth individuals who seek to diversify their real estate holdings through investments in individual projects rather than funds can now screen projects of interest in real time. Sponsors and investors can also choose to engage brokerage firms to list projects on their behalf and can continue to generate brokerage commissions while facilitating discussions with a more firm grasp of the project's underwriting. The sponsors and investors can leverage their brokerage skill and tap into a wider audience and can expedite the transition from due diligence to final negotiation while providing the knowledge base and resources of a skilled brokerage operation.

In addition to the commercial and governmental users of the automated analytic framework, the breadth and interrelation of data captured can also make the automated analytic framework a good fit for real estate development academic programs. The automated analytic framework can effectively digitize much of the knowledge base accumulated in nationally renowned Master of Real Estate Development (MRED) and similar programs. Despite likely charging a lower per-user charge to encourage adoption by these academic programs, the number of students per institution that can have access to the automated analytic framework can be larger than the anticipated commercial and governmental institutional adoption rate. Additionally, by bringing the automated analytic framework into an academic setting, the company can promote future adoption from academic users who can gain familiarity with the invention and its uses prior to rejoining the workforce. Educational users can leverage the automated analytic framework's compilation of industry best practices and real-world data to more easily compile case studies and apply their learned skills in a setting that accurately reflects the dynamics of development in the real world.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. (canceled)

2. A computer-implemented method comprising:
receiving data indicating a selection by a user of a particular view on a map interface provided by a real estate development project analytics platform;
determining that one or more properties that are visible in the particular view on the map interface provided by the real estate development project analytics platform are characterized as underutilized properties;
obtaining, for each of the one or more properties that are visible in the particular view on the map interface provided by the real estate development project analytics platform and that are characterized as underutilized properties, a set of development parameters for developing the underutilized property, the set of development parameters including at least:
(i) one or more stored, project assumption parameters that were previously, explicitly input by the user, including a parameter that indicates a project type,
(ii) one or more site-specific parameters that are explicitly associated with the property in one or more publicly-accessible information databases and that are obtained in real-time to determining that the property is visible in the particular view on the map interface provided by the real development estate project analytics platform, and
(iii) one or more derived parameters that are not explicitly associated with the property in any of the publicly accessible information databases but that are associated with a user-specified quantity of one or more other properties that indicated as similar to the project type and as similar in location with the property that is visible in the particular view on the map interface provided by the real estate development project analytics platform;
generating, for each of the one or more properties that are visible in the particular view on the map interface provided by the real estate development project analytics platform and based on the set of development parameters, optimal use parameters relating to optimal utilization of the property;
generating, for each of the one or more properties that are visible in the particular view on the map interface provided by the real estate development project analytics platform and based on the optimal use parameters, (i) analytical information and (ii) a three-dimensional visualization of a proposed building that satisfies the optimal use parameters;
providing, for output on a massing analysis interface provided by the real estate development project analytics platform, and for each of the one or more properties that are visible in the particular view on the map interface provided by the real estate development project analytics platform, (i) a representation of the analytical information, and (ii) the three-dimensional visualization of the proposed building that satisfies the optimal use parameters, in context with three-dimensional models of one or more other buildings that are adjacent to the property on the map interface; and
submitting an analytics package for the one or more properties that are characterized as underutilized properties, including at least (i) the project assumption parameters, (ii) the site-specific parameters, (iii) the derived parameters, for storage among multiple other analytics packages associated with other properties that are also characterized as underutilized properties, and (iv) analytical information, in an analytics package database that is searchable by other users of the real estate development project analytics platform using analytical information as a search parameter.

3. The method of claim 2, wherein the map interface and the massing analysis interface are provided by a cloud-hosted application implemented using a software-as-a-service delivery model by one or more servers that are disposed over a network from a client device that is operated by the user.

4. The method of claim 2, wherein receiving the data indicating a selection by a user of a particular view on a map interface within a real estate development project analytics platform comprises determining, by a global positioning system sensor implemented on a mobile device associated with the user, a current location associated with the user.

5. The method of claim 2, comprising:
receiving, by a search engine associated with the real estate development project analytics platform, a search query from another user, the search query including desired analytical information as a search parameter;
determining, by the search engine associated with the real estate development project analytics platform, that analytical information included in the analytics package for the one or more properties that are characterized as underutilized properties matches the desired analytical information; and
providing, by the real estate development project analytics platform and to the other user, a search results interface that includes a representation of the analytics package.

6. The method of claim 2, wherein receiving data indicating the selection by the user of the particular view on the map interface comprises receiving data identifying a location of one or more of the properties that are visible in the particular view on the map interface provided by the real estate development project analytics platform.

7. The method of claim 2, wherein receiving data indicating the selection by the user of the particular view on the map interface comprises receiving data identifying a respective address of one or more of the properties that are visible in the particular view on the map interface provided by the real estate development project analytics platform.

8. The method of claim 2, wherein generating, for each of the one or more properties that are visible in the particular view on the map interface provided by the real estate development project analytics platform, the optimal use parameters relating to optimal utilization of the property comprises determining a maximum by-right value associated with maximum or highest use of the property.

9. The method of claim 2, comprising, after the analytics package is stored in the analytics package database:
accessing the analytics package by the user or by one or more of the other users;
receiving (i) an update to one or more of the project assumption parameters from the user or from one or more of the other users, or (ii) a update to one or more of the site-specific parameters that is obtained in real time to accessing the analytics package;
determining that the updated one or more parameters impacts one or more of the project assumption parameters that were originally stored in the analytics package prior to receiving the update;
providing a notification by the real estate development project analytics platform to the user or to the one or more other users, indicating an implication of the update to the analytical information; and
storing the updated one or more parameters in a log of changes in the analytics package.

10. The method of claim 2, comprising:
receiving an additional project assumption parameter that is explicitly input by the user, and that overrides a particular site-specific parameter that was obtained from one or more of the publicly accessible information databases;
re-generating the optimal user parameters, the analytical information, and the three-dimensional visualization of the proposed building, using the additional project assumption parameter instead of the particular, overridden site-specific parameter, and
providing a representation of the re-generated analytical information and the re-generated three-dimensional visualization of the proposed building for output.

11. The method of claim 2, comprising, for each providing the one or more site-specific parameters for output and selection as suggested constraints for each of the one or more properties.

12. The method of claim 2, comprising:
generating, by a computing device, an image of one or more of the properties using a camera on the computing device; and
storing the image of the one or more properties in the analytics package.

13. The method of claim 2, wherein one or more project assumption parameters reflects a financing structure, and has a value that is selected from among a group consisting of a traditional mortgage financing structure, a federal housing authority (FHA) mortgage financing structure, and a local subsidy financing structure.

14. The method of claim 2, wherein the analytics package includes an access control list that identifies which of the one or more other users are authorized by the user to view one or more of the parameters.

15. The method of claim 2, wherein the one or more site-specific parameters that are explicitly associated with the property in one or more publicly-accessible information databases comprise (i) one or more parameters that represent “by right” zoning attributes associated with the property, and (ii) one or more parameters that represent alterations to the “by right” zoning attributes, and that are current when the site-specific parameters are obtained.

16. The method of claim 2, wherein the one or more site-specific parameters that are explicitly associated with the property in one or more publicly-accessible information databases comprise (i) one or more parameters that represent zoning attributes that are derived from zoning code associated with a municipality, and (ii) one or more parameters that represent constraints on the zoning attributes that are associated with a specially designated sub-district of the municipality.

17. A non-transitory computer-readable medium storing software comprising instructions executable by one or more computers which, upon such execution, cause the one or more computers to perform operations comprising:
receiving data indicating a selection by a user of a particular view on a map interface provided by a real estate development project analytics platform;
determining that one or more properties that are visible in the particular view on the map interface provided by the real estate development project analytics platform are characterized as underutilized properties;
obtaining, for each of the one or more properties that are visible in the particular view on the map interface provided by the real estate development project analytics platform and that are characterized as underutilized properties, a set of development parameters for developing the underutilized property, the set of development parameters including at least:
(i) one or more stored, project assumption parameters that were previously, explicitly input by the user, including a parameter that indicates a project type,
(ii) one or more site-specific parameters that are explicitly associated with the property in one or more publicly-accessible information databases and that are obtained in real-time to determining that the property is visible in the particular view on the map interface provided by the real development estate project analytics platform, and
(iii) one or more derived parameters that are not explicitly associated with the property in any of the publicly accessible information databases but that are associated with a user-specified quantity of one or more other properties that indicated as similar to the project type and as similar in location with the property that is visible in the particular view on the map interface provided by the real estate development project analytics platform;
generating, for each of the one or more properties that are visible in the particular view on the map interface provided by the real estate development project analytics platform and based on the set of development parameters, optimal use parameters relating to optimal utilization of the property;
generating, for each of the one or more properties that are visible in the particular view on the map interface provided by the real estate development project analytics platform and based on the optimal use parameters, (i) analytical information and (ii) a three-dimensional visualization of a proposed building that satisfies the optimal use parameters;
providing, for output on a massing analysis interface provided by the real estate development project analytics platform, and for each of the one or more properties that are visible in the particular view on the map interface provided by the real estate development project analytics platform, (i) a representation of the analytical information, and (ii) the three-dimensional visualization of the proposed building that satisfies the optimal use parameters, in context with three-dimensional models of one or more other buildings that are adjacent to the property on the map interface; and
submitting an analytics package for the one or more properties that are characterized as underutilized properties, including at least (i) the project assumption parameters, (ii) the site-specific parameters, (iii) the derived parameters, for storage among multiple other analytics packages associated with other properties that are also characterized as underutilized properties, and (iv) analytical information, in an analytics package database that is searchable by other users of the real estate development project analytics platform using analytical information as a search parameter.

18. A system comprising:
one or more computers and one or more storage devices storing instructions that are operable, when executed by the one or more computers, to cause the one or more computers to perform operations comprising:
receiving data indicating a selection by a user of a particular view on a map interface provided by a real estate development project analytics platform;
determining that one or more properties that are visible in the particular view on the map interface provided by the real estate development project analytics platform are characterized as underutilized properties;
obtaining, for each of the one or more properties that are visible in the particular view on the map interface provided by the real estate development project analytics platform and that are characterized as underutilized properties, a set of development parameters for developing the underutilized property, the set of development parameters including at least:
(i) one or more stored, project assumption parameters that were previously, explicitly input by the user, including a parameter that indicates a project type,
(ii) one or more site-specific parameters that are explicitly associated with the property in one or more publicly-accessible information databases and that are obtained in real-time to determining that the property is visible in the particular view on the map interface provided by the real development estate project analytics platform, and
(iii) one or more derived parameters that are not explicitly associated with the property in any of the publicly accessible information databases but that are associated with a user-specified quantity of one or more other properties that indicated as similar to the project type and as similar in location with the property that is visible in the particular view on the map interface provided by the real estate development project analytics platform;
generating, for each of the one or more properties that are visible in the particular view on the map interface provided by the real estate development project analytics platform and based on the set of development parameters, optimal use parameters relating to optimal utilization of the property;
generating, for each of the one or more properties that are visible in the particular view on the map interface provided by the real estate development project analytics platform and based on the optimal use parameters, (i) analytical information and (ii) a three-dimensional visualization of a proposed building that satisfies the optimal use parameters;
providing, for output on a massing analysis interface provided by the real estate development project analytics platform, and for each of the one or more properties that are visible in the particular view on the map interface provided by the real estate development project analytics platform, (i) a representation of the analytical information, and (ii) the three-dimensional visualization of the proposed building that satisfies the optimal use parameters, in context with three-dimensional models of one or more other buildings that are adjacent to the property on the map interface; and
submitting an analytics package for the one or more properties that are characterized as underutilized properties, including at least (i) the project assumption parameters, (ii) the site-specific parameters, (iii) the derived parameters, for storage among multiple other analytics packages associated with other properties that are also characterized as underutilized properties, and (iv) analytical information, in an analytics package database that is searchable by other users of the real estate development project analytics platform using analytical information as a search parameter.

19. The system of claim 18, wherein the map interface and the massing analysis interface are provided by a cloud-hosted application implemented using a software-as-a-service delivery model by one or more servers that are disposed over a network from a client device that is operated by the user.

20. The system of claim 18, wherein receiving the data indicating a selection by a user of a particular view on a map interface within a real estate development project analytics platform comprises determining, by a global positioning system sensor implemented on a mobile device associated with the user, a current location associated with the user.

21. The system of claim 18, wherein the operations comprise:
receiving, by a search engine associated with the real estate development project analytics platform, a search query from another user, the search query including desired analytical information as a search parameter;
determining, by the search engine associated with the real estate development project analytics platform, that analytical information included in the analytics package for the one or more properties that are characterized as underutilized properties matches the desired analytical information; and
providing, by the real estate development project analytics platform and to the other user, a search results interface that includes a representation of the analytics package.
